(19) United States
(12) Patent Application Publication
(10) Pub. No.: US 2012/0049673 A1
(43) Pub. Date: Mar. 1, 2012

(54) Generator System for Water Tank

(76) Inventor: Myung Hoe KOO, Rowland Heights, CA (US)

(21) Appl. No.: 12/868,365

(22) Filed: Aug. 25, 2010

(51) Int. Cl. H02K 7/06; H02K 47/04

(52) U.S. Cl. 310/80; 310/113

(57) ABSTRACT

The invention provides a generator system comprising a water tank, a dividing wall, first and second cylinder plates, a pulley, an electrical motor, a turbine generator, a solar panel, a battery, and a return pipe. Each of the cylinder plates is disposed and configured to perform a piston movement through the corresponding vertical column of the water tank, and the first cylinder plate comprises a plurality of one-way holes for allowing water to flow downward only. The pulley connects the cylinder plates through a rope. The electrical motor is for driving the pulley for lifting either the first or the second cylinder plate. The turbine generator is disposed at the bottom opening of the water tank and for generating electricity with water flow generated by falling cylinder plates. The solar panel is disposed on the water tank for generating electrical power from solar beam.

### BACKGROUND OF THE INVENTION

The present invention relates to a generator system for water tank.

Big water tanks are being used widely. Such water tanks may be used to generate electricity using some devices.

Since water tanks are almost everywhere, there must be some good use of them.

### SUMMARY OF THE INVENTION

The present invention contrives to solve the disadvantages of the prior art.

An object of the invention is to provide a generator system for water tank.

An aspect of the invention provides a generator system for water tank comprising a water tank, a dividing wall, a first cylinder plate, a second cylinder plate, a pulley, an electrical motor, a turbine generator, a solar panel, a battery, and a return pipe.

The water tank has a top opening and a bottom opening.

The dividing wall is disposed vertically in the water tank dividing the water tank into a first vertical column and a second vertical column, and the first vertical column and the second vertical column join in a vicinity of the bottom opening of the water tank.

The first cylinder plate is disposed and configured to perform a piston movement through the first vertical column of the water tank, and the first cylinder plate comprises a plurality of one-way holes for allowing water to flow downward only.

The second cylinder plate is disposed and configured to perform a piston movement through the second vertical column of the water tank, and the second cylinder plate comprises a plurality of one-way holes for allowing water to flow downward only.

The pulley connects the first cylinder plate and the second cylinder plate through a rope.

The electrical motor is for driving the pulley for lifting either the first cylinder plate or the second cylinder plate.

The turbine generator is disposed at the bottom opening of the water tank and for generating electricity with water flow generated by falling cylinder plates.

The solar panel is disposed on an outer surface of the water tank for generating electrical power from solar beam, and the generated electrical power operates the electrical motor.

The battery is for storing a part of the electrical power generated by the solar panel and supplying to the electrical motor.

The return pipe has a lower end disposed at the bottom opening of the water tank and a higher end opened to the top opening of the water tank for returning water from the turbine generator to the water tank.

The water tank may be evenly divided by the dividing wall into the first and second vertical columns.

The water tank may have a shape of a cylinder.

The dividing wall may extend from the top opening to the bottom opening of the water tank.

The water may flow freely to and from each of the first and second vertical columns.

The dividing wall may comprise a through-hole disposed at a first height for connecting the first and second vertical columns for allowing water to flow therethrough.

The first cylinder plate may be configured to fit to walls enclosing the first vertical column sealingly, slidably, and substantially frictionlessly.

The second cylinder plate may be configured to fit to walls enclosing the second vertical column sealingly, slidably, and substantially frictionlessly.

The return pipe may be configured to pour water to the first and second vertical columns evenly.

The return pipe may comprise two outlet openings, each of which being opened to one of the first and second vertical columns.

The generator system may further comprise: a water supply inlet configured to supply water to the water tank at the top opening externally and evenly to the first and second vertical columns; and a water supply outlet configured to supply water in the water tank to outside.

The water supply outlet may be disposed below the level of a lowest point of the dividing wall, and the water supply inlet may be disposed above the through-hole.

The generator system may further comprise a controller for controlling the operating of the electrical motor.

Another aspect of the invention provides a generator system for water tank comprising a water tank, a cylinder plate, a shaft, an electrical motor, a plurality of turbine generators, a solar panel, a battery, a water level sensor, a plurality of baffle members, and a plurality of flow guide wedges.

The water tank has a top opening and a bottom opening.

The cylinder plate is disposed and configured to perform a piston movement through the water tank and to rotate.

The shaft is connected to a center of the cylinder plate, and the shaft is configured to be raised or lowered according to a level of water in the water tank such that a predetermined portion of the cylinder plate submerged in the water.

The electrical motor is for raising and lowering the shaft.

The plurality of turbine generators are disposed at on a bottom surface of the cylinder plate and radially around the center of the cylinder plate, and the plurality of turbine generators are configured to generate electricity with rotational movement of the cylinder plate.

The solar panel is disposed on an outer surface of the water tank for generating electrical power from solar beam, and the generated electrical power operates the electrical motor.

The battery is for storing a part of the electrical power generated by the solar panel and supplying to the electrical motor.

The water level sensor is disposed on a bottom surface of the cylinder plate for detecting the level of water and outputting electrical signal for controlling the electrical motor for raising or lowering the cylinder plate.

The plurality of baffle members are disposed inside the water tank and configured to prevent the water in the water tank from rotating along with the rotating rack arm.

The plurality of flow guide wedges are disposed in front sides of the turbine generators so as to guide water toward the turbine generators.

The level of water in the water tank is kept between a first level and a second level.

The bottom opening may be disposed at a location which is lower than the second level.

The generator system may further comprise a water supplying inlet for supplying water externally into the water tank.

The water supplying inlet may be disposed above the first level.

The advantages of the present invention are: (1) the generator system for water tank can generate electrical power in a water tank; (2) the generator system for water tank can use water in a water tank to generate electrical power conveniently; and (3) the generator system for water tank uses solar panel for operation.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view showing a generator system according to an embodiment of the invention;

FIG. 2 is a cross-sectional view along the line II-II in FIG. 1;

FIG. 3 is a perspective view showing a water supply inlet according to an embodiment of the invention;

FIG. 4 is a top plan view of a cylinder plate;

FIG. 5 is a cross-sectional view along the line V-V in FIG. 4;

FIG. 6 is a schematic diagram showing a generator system according to another embodiment of the invention;

FIG. 7 is a schematic diagram showing a turbine generator in FIG. 4;

FIG. 8 is a side view showing vanes disposed in front of turbine generators;

FIG. 9 is a schematic diagram showing a generator system according to still another embodiment of the invention; and

FIG. 10 is a top perspective view showing turbine generators and water guide wedges in a rack arm in a water tank.

### DETAILED DESCRIPTION EMBODIMENTS OF THE INVENTION

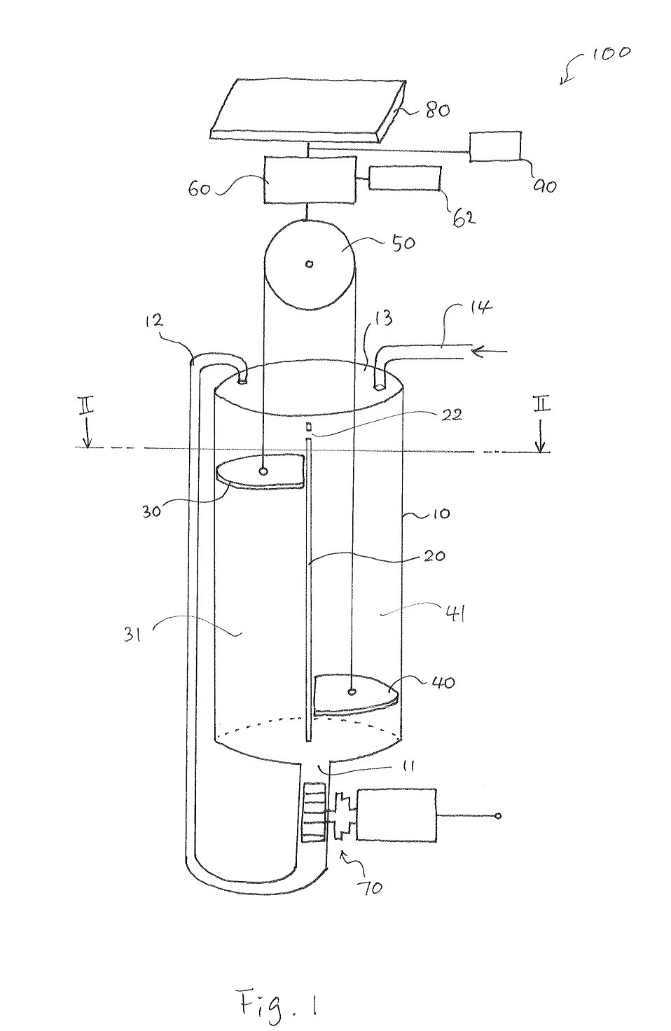

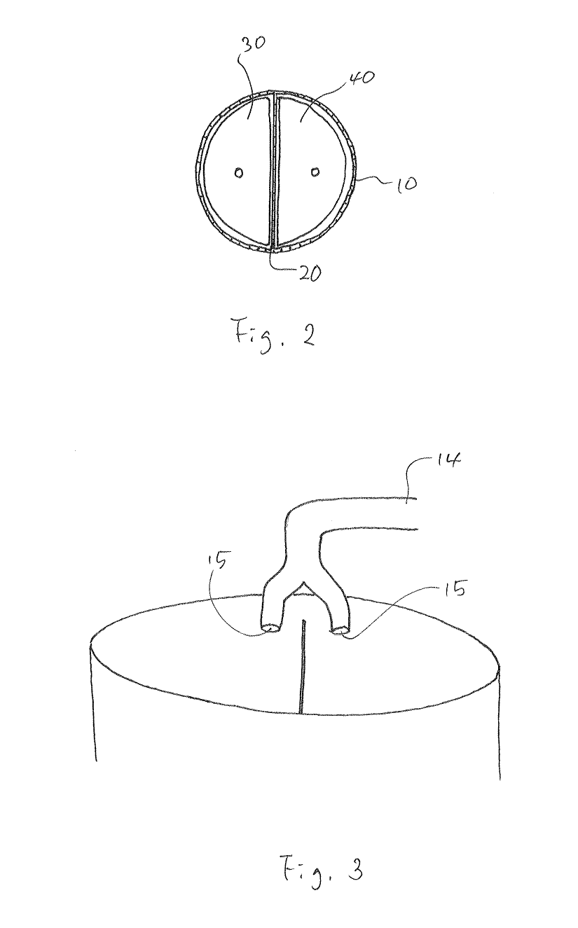

FIGS. 1-5 show a generator system 100 for water tank according to an embodiment of the invention.

The generator system 100 for water tank comprises a water tank 10, a dividing wall 20, a first cylinder plate 30, a second cylinder plate 40, a pulley 50, an electrical motor 60, a turbine generator 70, a solar panel 80, a battery 90, and a return pipe 12.

The water tank 10 has a top opening and a bottom opening.

The dividing wall 20 is disposed vertically in the water tank 10 dividing the water tank 10 into a first vertical column 31 and a second vertical column 41, and the first vertical column 31 and the second vertical column 41 join in a vicinity of the bottom opening of the water tank 10.

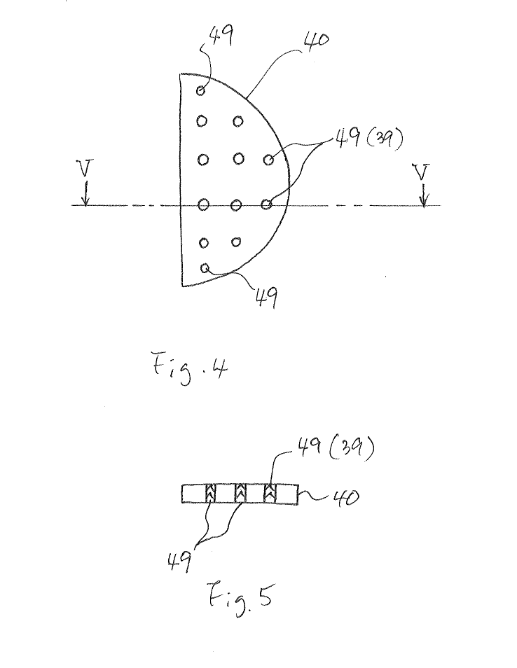

The first cylinder plate 30 is disposed and configured to perform a piston movement through the first vertical column 31 of the water tank 10, and the first cylinder plate 30 comprises a plurality of one-way holes 39 for allowing water to flow downward only just like those for the second cylinder plate 40 as shown in FIGS. 4 and 5.

The second cylinder plate 40 is disposed and configured to perform a piston movement through the second vertical column 41 of the water tank 10, and the second cylinder plate 40 comprises a plurality of one-way holes 49 for allowing water to flow downward only as shown in FIGS. 4 and 5.

The pulley 50 connects the first cylinder plate 30 and the second cylinder plate 40 through a rope.

The electrical motor 60 is for driving the pulley 50 for lifting either the first cylinder plate 30 or the second cylinder plate 40.

The turbine generator 70 is disposed at the bottom opening of the water tank 10 and for generating electricity with water flow generated by falling cylinder plates 30,40.

The solar panel 80 is disposed on an outer surface of the water tank 10 for generating electrical power from solar beam, and the generated electrical power operates the electrical motor 60.

The battery 90 is for storing a part of the electrical power generated by the solar panel 80 and supplying to the electrical motor 60.

The return pipe 12 has a lower end disposed at the bottom opening of the water tank 10 and a higher end opened to the top opening of the water tank 10 for returning water from the turbine generator 70 to the water tank 10.

The water tank 10 may be evenly divided by the dividing wall 20 into the first and second vertical columns.

The water tank 10 may have a shape of a cylinder.

The dividing wall 20 may extend from the top opening to the bottom opening of the water tank 10.

The water may flow freely to and from each of the first and second vertical columns.

The dividing wall 20 may comprise a through-hole 22 disposed at a first height for connecting the first and second vertical columns for allowing water to flow therethrough.

The first cylinder plate 30 may be configured to fit to walls enclosing the first vertical column sealingly, slidably, and substantially frictionlessly.

The second cylinder plate 40 may be configured to fit to walls enclosing the second vertical column sealingly, slidably, and substantially frictionlessly.

The return pipe 12 may be configured to pour water to the first and second vertical columns evenly.

The return pipe 12 may comprise two outlet openings, each of which being opened to one of the first and second vertical columns.

The generator system may further comprise: a water supply inlet 14 configured to supply water to the water tank 10 at the top opening externally and evenly to the first and second vertical columns; and a water supply outlet 16 configured to supply water in the water tank 10 to outside.

The water supply outlet 16 may be disposed below the level of a lowest point of the dividing wall 20, and the water supply inlet 14 may be disposed above the through-hole.

The generator system may further comprise a controller 62 for controlling the operating of the electrical motor 60.

The electrical energy from the solar panel 80 may power the electrical motor 60 in order to operate the pulley 50. Due to a weight of a cylinder plate 30, 40, another one of the cylinder plate 30, 40 may be easily lifted up from a lower position to a higher position. The motion of the cylinder plate 30, 40 makes a flow through the turbine of the turbine generator 70.

Such a movement of the cylinder plates 30, 40 may be used for the other purposes such as stirring the water in the water tank 10 for sanitary reasons.

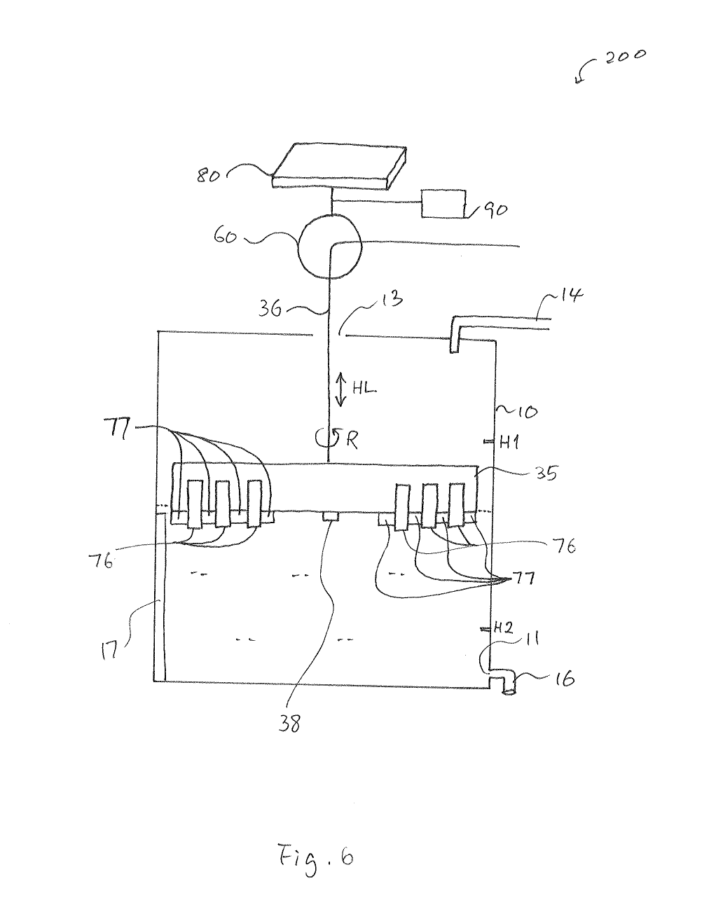

FIGS. 6-10 show a generator system 200 for water tank according to another embodiments of the invention.

The generator system 200 for water tank comprises a water tank 10, a rack arm 35, a shaft 36, an electrical motor 60, a plurality of turbine generators 76, a solar panel 80, a battery 90, a water level sensor 38, a plurality of baffle members 17, and a plurality of flow guide wedges 77.

The water tank 10 has a top opening 11 and a bottom opening 13.

The rack arm 35 is disposed and configured to perform a piston movement through the water tank 10 and to rotate.

The shaft 36 is connected to a center of the rack arm 35, and the shaft 36 is configured to be raised or lowered according to a level of water in the water tank 10 such that a predetermined portion of the rack arm 35 submerged in the water.

The electrical motor 60 is for raising and lowering the shaft.

The plurality of turbine generators 76 are disposed at on a bottom surface of the rack arm 35 and radially around the center of the rack arm, and the plurality of turbine generators 76 are configured to generate electricity with rotational movement of the rack arm 35.

The solar panel 80 is disposed on an outer surface of the water tank 10 for generating electrical power from solar beam, and the generated electrical power operates the electrical motor 60.

The battery 90 is for storing a part of the electrical power generated by the solar panel 80 and supplying to the electrical motor 60.

The water level sensor 38 is disposed on a bottom surface of the rack arm 35 for detecting the level of water and outputting electrical signal for controlling the electrical motor 60 for raising or lowering the rack arm 35.

The plurality of baffle members 17 are disposed inside the water tank 10 and configured to prevent the water in the water tank 10 from rotating along with the rotating rack arm 35. The plurality of baffle members 17 may be disposed vertically along the inner surface of the water tank 10.

The plurality of flow guide wedges 77 are disposed in front sides of the turbine generators 76 so as to guide water toward the turbine generators 76.

The level of water in the water tank 10 is kept between a first level H1 and a second level H2.

The bottom opening may be disposed at a location which is lower than the second level H2.

The generator system 200 may further comprise a water supplying inlet 14 for supplying water externally into the water tank 10.

The water supplying inlet 14 may be disposed above the first level H1.

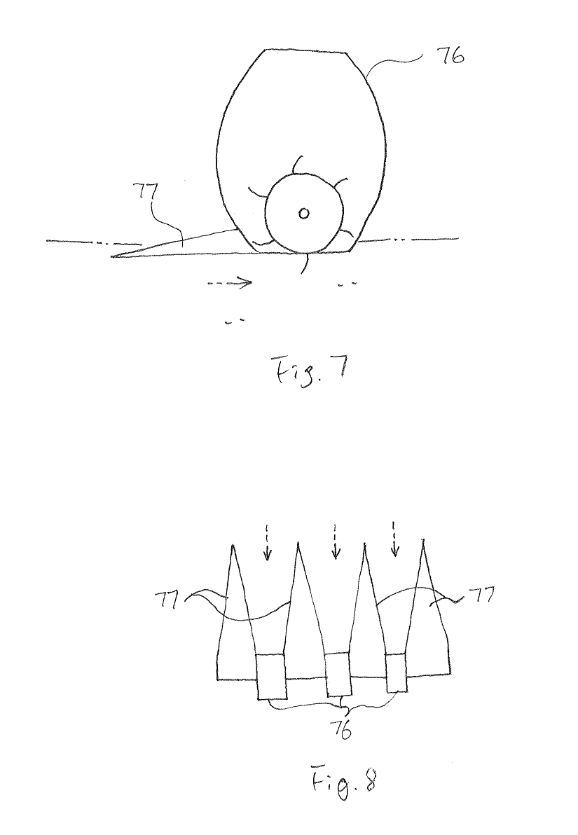

The rack arm 35 may be lifted up and down (HL) and rotated (R). The lifting and lowering of the rack arm 35 is for immersing the plurality of turbine generators 76 in an optimal depth. And, the rotating of the rack arm 35 is for flowing the water against the turbines of the turbine generators 76 for generating the electricity as shown in FIG. 7.

The turbine may be coated with teflon to facilitate repelling water on the surface as shown in FIG. 8.

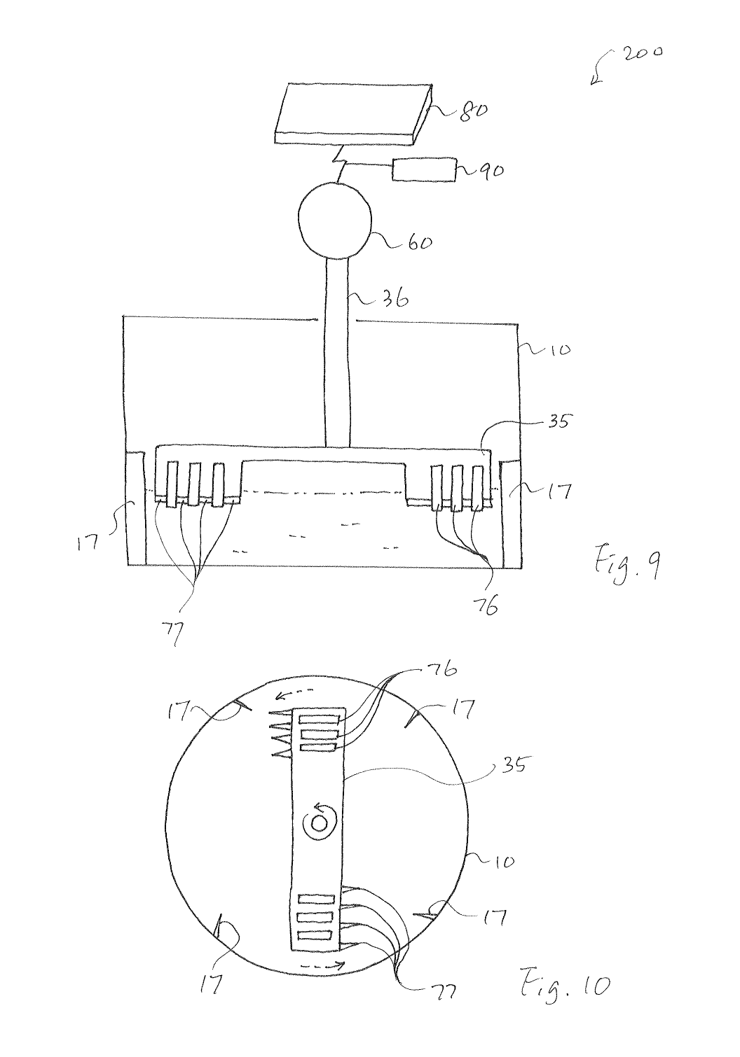

In still another embodiment of the invention shown in FIGS. 9 and 10, the water tank 10 may not have an outlet for extract water from the water tank 10.

In the above embodiments of the invention, the turbine generators 76 may comprise a rotor (not shown) and a stator (not shown) with a high efficiency. The rotor may comprise one or more permanent magnets, and the stator may comprise a plurality of coils. In still another embodiments, the rotor may comprise a plurality of coils, and the stator may comprise one or more permanent magnets.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A generator system for water tank comprising:
a water tank having a top opening and a bottom opening;
a dividing wall disposed vertically in the water tank dividing the water tank into a first vertical column and a second vertical column, wherein the first vertical column and the second vertical column join in a vicinity of the bottom opening of the water tank;
a first cylinder plate disposed and configured to perform a piston movement through the first vertical column of the water tank, wherein the first cylinder plate comprises a plurality of one-way holes for allowing water to flow downward only;
a second cylinder plate disposed and configured to perform a piston movement through the second vertical column of the water tank, wherein the second cylinder plate comprises a plurality of one-way holes for allowing water to flow downward only;
a pulley connecting the first cylinder plate and the second cylinder plate through a rope;
an electrical motor for driving the pulley for lifting either the first cylinder plate or the second cylinder plate;
a turbine generator disposed at the bottom opening of the water tank and for generating electricity with water flow generated by falling cylinder plates;
a solar panel disposed on an outer surface of the water tank for generating electrical power from solar beam, wherein the generated electrical power operates the electrical motor;
a battery 90 for storing a part of the electrical power generated by the solar panel and supplying to the electrical motor; and
a return pipe 12 having a lower end disposed at the bottom opening of the water tank and a higher end opened to the top opening of the water tank for returning water from the turbine generator to the water tank.

2. The generator system of claim 1, wherein the water tank is evenly divided by the dividing wall into the first and second vertical columns.

3. The generator system of claim 2, wherein the water tank has a shape of a cylinder.

4. The generator system of claim 1, wherein the dividing wall extends from the top opening to the bottom opening of the water tank.

5. The generator system of claim 4, wherein water flows freely to and from each of the first and second vertical columns.

6. The generator system of claim 4, wherein the dividing wall comprises a through-hole disposed at a first height for connecting the first and second vertical columns for allowing water to flow therethrough.

7. The generator system of claim 6, wherein the first cylinder plate is configured to fit to walls enclosing the first vertical column sealingly, slidably, and substantially frictionlessly.

8. The generator system of claim 7, wherein the second cylinder plate is configured to fit to walls enclosing the second vertical column sealingly, slidably, and substantially frictionlessly.

9. The generator system of claim 1, wherein the return pipe is configured to pour water to the first and second vertical columns evenly.

10. The generator system of claim 9, wherein the return pipe comprises two outlet openings, each of which being opened to one of the first and second vertical columns.

11. The generator system of claim 1, further comprising:
a water supply inlet configured to supply water to the water tank at the top opening externally and evenly to the first and second vertical columns; and
a water supply outlet configured to supply water in the water tank to outside.

12. The generator system of claim 11, wherein the water supply outlet is disposed below the level of a lowest point of the dividing wall, and wherein the water supply inlet is disposed above the through-hole.

13. The generator system of claim 1, further comprising a controller for controlling the operating of the electrical motor.

14. A generator system for water tank comprising:
a water tank having a top opening and a bottom opening;
a rack arm disposed and configured to be raised or lowered through the water tank and to rotate;
a shaft connected to a center of the rack arm, wherein the shaft is configured to be raised or lowered according to a level of water in the water tank such that a predetermined portion of the rack arm submerged in the water;
an electrical motor for raising and lowering the shaft;
a plurality of turbine generators disposed at on a bottom surface of the rack arm and radially around the center of the rack arm, wherein the plurality of turbine generators are configured to generate electricity with rotational movement of the rack arm;
a solar panel disposed on an outer surface of the water tank for generating electrical power from solar beam, wherein the generated electrical power operates the electrical motor;
a battery for storing a part of the electrical power generated by the solar panel and supplying to the electrical motor;
a water level sensor disposed on a bottom surface of the rack arm for detecting the level of water and outputting electrical signal for controlling the electrical motor for raising or lowering the rack arm;
a plurality of baffle members disposed inside the water tank and configured to prevent the water in the water tank from rotating along with the rotating rack arm; and
a plurality of flow guide wedges disposed in front sides of the turbine generators so as to guide water toward the turbine generators,
wherein the level of water in the water tank is kept between a first level and a second level.

15. The generator of claim 14, wherein the bottom opening is disposed at a location which is lower than the second level.

16. The generator of claim 15, further comprising a water supplying inlet for supplying water externally into the water tank, wherein the water supplying inlet is disposed above the first level.
